(19) United States
(12) Patent Application Publication
(10) Pub. No.: US 2024/0000119 A1
(43) Pub. Date: Jan. 4, 2024

(54) MEGASTIGMANE DERIVATIVE COMPOSITIONS AND METHODS FOR TASTE MODULATION

(71) Applicant: INTERNATIONAL FLAVORS & FRAGRANCES, Union Beach, NJ (US)

(72) Inventors: Hou Wu, East Brunswick, NJ (US); Diana Klaser Cheng, Highland Park, NJ (US); Thumpalasseril V. John, Morganville, NJ (US); Michelle Eve Huber, Cream Ridge, NJ (US); Hassan Mustaq Ubaideen, Aberdeen, NJ (US); Jing Li, Aberdeen, NJ (US); Xiao-Qing Tang, Holmdel, NJ (US); Yanpeng Hou, Holmdel, NJ (US); Ajay Pratap Singh, Highland Park, NJ (US)

(21) Appl. No.: 18/253,630

(22) PCT Filed: Dec. 15, 2021
(86) PCT No.: PCT/US2021/063439

§ 371 Date: May 19, 2023

Related U.S. Application Data
(60) Provisional application No. 63/118,088, filed on Nov. 25, 2020.

(51) Int. Cl. A23L 27/30; A23L 27/10; A23L 27/00

(52) U.S. Cl. CPC A23L 27/34; A23L 27/10; A23L 27/88

(57) ABSTRACT

The use of a megastigmane derivative to enhance the sweetness of a sweetness modifier and to decrease the amount of a sweetness modifier used in a consumable is provided.

### RELATED APPLICATIONS

This application is a 371 of International Application Number PCT/US2021/063439, filed Dec. 15, 2021, which claims the benefit of U.S. Provisional Application No. 63/118,088, filed Nov. 25, 2020, which are incorporated by reference in their entirety.

### BACKGROUND OF INVENTION

Reducing sugar content in food and beverages has become a necessity in the food industry. Food and beverage manufacturers generally use non-caloric, high-intensity sweetness modifiers, such as rebaudioside A (Reb A), aspartame, saccharin, glycosylated steviol glycosides, etc., to partially or completely replace sugar. However, these sweetness modifiers may exhibit undesirable taste attributes such as delayed onset of sweetness, bitter and astringent aftertaste, and lack of body and mouthfeel. Consequently, sweetness enhancers have become valuable tools, which reduce the use of sugar and/or sweetness modifiers, in achieving the desired sweetness intensity and mouthfeel with reduced off-taste.

Sweetness enhancers have been described in the prior art. For example, WO 2013/143822 teaches the use of adenosine as sweetness enhancer for certain sugars; EP 2606747 describes the use of deoxycholic acid or a derivative thereof for enhancing the sweetness of consumables; WO 2013/077668 describes the sweetness enhancing effect of a glycan or glycopeptide derived from soy sauce; WO 2012/107203 teaches the use of nobiletin or a derivative or a hydrate thereof as a sweetener or sweetness enhancer; WO 2009/023975 describes the use of iso-mogroside V as a sweetener and sweetness enhancer; US 2008/0242740 teaches aroma compositions of alkamides with hesperetin and/or 4-hydroxydihydrochalcones for enhancing sweet sensory impressions; and WO 2007/014879 and WO 2007/107596 respectively teach the use of hesperetin and 4-hydroxydihydrochalcones for enhancing the sweet taste of a sweet-tasting substance or sweet olfactory impression of a flavoring.

### SUMMARY OF THE INVENTION

This invention provides a method of enhancing the sweetness of a sweetness modifier by adding an olfactory effective amount of a megastigmane derivative represented by Formula I set forth below:

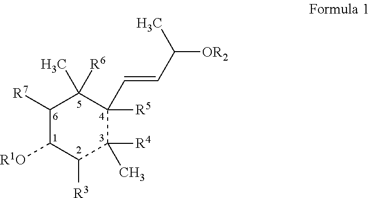

wherein one of R¹ and R² represents hydrogen and the other one thereof represents a sugar moiety;
R³, R⁴, R⁵, R⁶ and R⁷ are independently selected from the group consisting of hydrogen, a methyl group and a hydroxy group, or R⁴ and R together form a group —O—; and
wherein a dashed line represents an optional carbon-carbon double bond, with the proviso that the dashed line between carbon atom 2 and carbon atom 3 and the dashed line between carbon atom 3 and carbon atom 4 do not simultaneously represent a carbon-carbon double bond; and
with the further proviso that when the dashed line between carbon atom 1 and oxygen represents a carbon-carbon double bond, R¹ is absent, when the dashed line between carbon atom 2 and carbon atom 3 represents a carbon-carbon double bond, R⁴ is absent, and when the dashed line between carbon atom 3 and carbon atom 4 represents a carbon-carbon double bond, R⁴ and R⁵ are absent.

More specifically, the above megastigmane derivative is represented by Formula II set forth below:

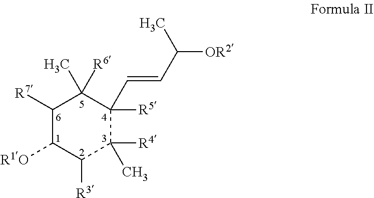

wherein R^{1′} represents hydrogen and R^{2′} represents a sugar moiety;
R^{3′}, R^{4′}, R^{5′}, R^{6′} and R^{7′} are independently selected from the group consisting of hydrogen, a methyl group and a hydroxy group; and
wherein a dashed line represents an optional carbon-carbon double bond, with the proviso that the dashed line between carbon atom 2 and carbon atom 3 and the dashed line between carbon atom 3 and carbon atom 4 do not simultaneously represent a carbon-carbon double bond; and
with the further proviso that when the dashed line between carbon atom 1 and oxygen represents a carbon-carbon double bond, R¹ is absent, when the dashed line between carbon atom 2 and carbon atom 3 represents a carbon-carbon double bond, R⁴ is absent, and when the dashed line between carbon atom 3 and carbon atom 4 represents a carbon-carbon double bond, R⁴ and R⁵ are absent.

More specifically, the sugar moiety in the above megastigmane derivative is glucose.

In one embodiment, the present invention is directed to a method of enhancing the sweetness of a sweetness modifier comprising the step of adding an olfactory effective amount of a sweetness enhancer containing a megastigmane derivative to the sweetness modifier.

In another embodiment, the present invention is directed to a method of enhancing the sweetness of a sweetness modifier comprising the step of adding an olfactory effective amount of a sweetness enhancer containing a megastigmane derivative and a flavoring to the sweetness modifier.

In another embodiment, the present invention is directed to a composition comprising a sweetness modifier and an olfactory effective amount of a sweetness enhancer containing a megastigmane derivative.

In another embodiment, the present invention is directed to a composition comprising a sweetness modifier and an olfactory effective amount of a sweetness enhancer containing a megastigmane derivative and a flavoring.

In another embodiment, the present invention is directed to a consumable comprising a sweetness modifier and an olfactory effective amount of a sweetness enhancer containing a megastigmane derivative.

In another embodiment, the present invention is directed to a consumable comprising a sweetness modifier and an olfactory effective amount of a sweetness enhancer containing a megastigmane derivative and a flavoring.

These and other embodiments of the present invention will be apparent by reading the following specification.

### DETAILED DESCRIPTION OF THE INVENTION

The megastigmane derivatives of the present invention contain chiral centers, thereby providing a number of isomers. It is intended herein that the megastigmane derivatives described herein include individual isomers as well isomeric mixtures. Some of the megastigmane derivatives of the present invention may be represented by the following structures:

### 4-Hydroxy-3,3,5-trimethyl-4-(3-((3,4,5-trihydroxy-6-(hydroxymethyl)tetrahydro-2H-pyran-2-yl)oxy)but-1-en-1-yl)cyclohexan-1-one (Structure 1)

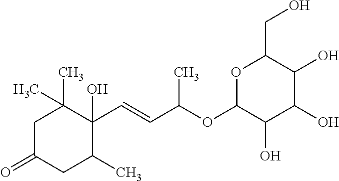 [SMILES: CC(/C=C/C1(O)C(C)CC(=O)CC1(C)C)OC1OC(CO)C(O)C(O)C1O]

Structure 1 may further specifically represent, for example, but not limited to, (7E)-6,9-dihydromegastigma-7-ene-3-one-9-O-β-glucopyranoside (CAS registry number 142235-27-6), (4S)-dihydroroseoside (CAS registry number 351343-53-8), lauroside A (CAS registry number 820259-65) or ampelopsisionoside (CAS registry number 138665-44-8).

### 2-((4-(3,4-Dihydroxy-2,6,6-trimethylcyclohex-1-en-1-yl)but-3-en-2-yl)oxy)-6-(hydroxymethyl)tetrahydro-2H-pyran-3,4,5-triol (Structure 2)

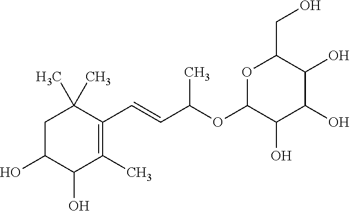 [SMILES: CC1=C(/C=C/C(C)OC2OC(CO)C(O)C(O)C2O)C(C)(C)CC(O)C1O]

Structure 2 may further specifically represent, for example, but not limited to, bridelionoside F (CAS registry number 917877-42-0), phlomisionoside (CAS registry number 558451-77-7), debiloside B (CAS registry number 866033-71-8) or vajicoside (CAS registry number 2226037-61-0).

### 4-Hydroxy-3,5,5-trimethyl-4-(3-((3,4,5-trihydroxy-6-(hydroxymethyl)tetrahydro-2H-pyran-2-yl)oxy)but-1-en-1-yl)cyclohex-2-en-1-one (Structure 3)

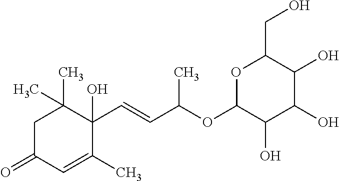 [SMILES: CC1=CC(=O)CC(C)(C)C1(O)/C=C/C(C)OC1OC(CO)C(O)C(O)C1O]

Structure 3 may further specifically represent, for example, but not limited to, roseoside (CAS registry number 54835-70-0), corchoionoside C (CAS registry number 185414-25-9), (6R,9S)-roseoside (CAS registry number 723334-68-7), cis-roseoside (CAS registry number 394653-65-7), (6R,9R)-roseoside (CAS registry number 167934-03-4), (4S)-4-[(3S)-3-(β-D-glucopyranosyloxy)-1-buten-1-yl]-4-hydroxy-3,5,5-trimethyl-2-cyclohexen-1-one (CAS registry number 1421688-54-1), (4S)-4-[(1E)-3-(β-D-glucopyranosyloxy)-1-buten-1-yl]-4-hydroxy-3,5,5-trimethyl-2-cyclohexen-1-one (CAS registry number 380861-18-7) or 4-[(1E)-3-(β-D-glucopyranosyloxy)-1-buten-1-yl]-4-hydroxy-3,5,5-trimethyl-2-cyclohexen-1-one (CAS registry number 214976-29-1).

### 2-Hydroxy-3,5,5-trimethyl-4-(3-((3,4,5-trihydroxy-6-(hydroxymethyl)tetrahydro-2H-pyran-2-yl)oxy)but-1-en-1-yl)cyclohex-2-en-1-one (Structure 4)

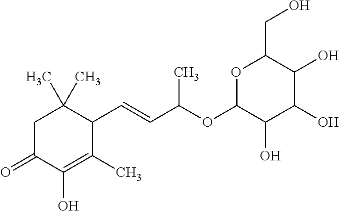 [SMILES: CC1=C(O)C(=O)CC(C)(C)C1/C=C/C(C)OC1OC(CO)C(O)C(O)C1O]

Structure 4 may further specifically represent, for example, but not limited to, (2R)-4-[(1E,3R)-3-(β-D-glucopyranosyloxy)-1-buten-1-yl]-2-hydroxy-3,5,5-trimethyl-3-cyclohexen-1-one (CAS registry number 208929-32-2).

### (4,6-Dihydroxy-3,5,5-trimethyl-4-(3-((3,4,5-trihydroxy-6-(hydroxymethyl)tetrahydro-2H-pyran-2-yl)oxy)but-1-en-1-yl)cyclohex-2-en-1-one (Structure 5)

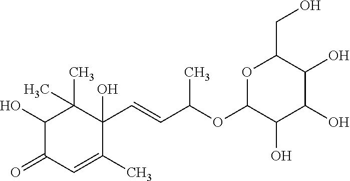 [SMILES: CC1=CC(=O)C(O)C(C)(C)C1(O)/C=C/C(C)OC1OC(CO)C(O)C(O)C1O]

Structure 5 may further specifically represent, for example, but not limited to, sauroposide (CAS registry number 610783-40-9).

### 2-(Hydroxymethyl)-6-((4-(1,2,4-trihydroxy-2,6,6-trimethylcyclohexyl)but-3-en-2-yl)oxy)tetrahydro-2H-pyran-3,4,5-triol (Structure 6)

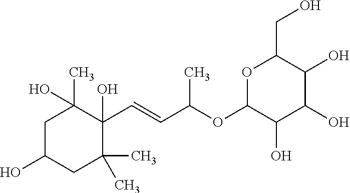 [SMILES: CC(/C=C/C1(O)C(C)(C)CC(O)CC1(C)O)OC1OC(CO)C(O)C(O)C1O]

Structure 6 may further specifically represent, for example, but not limited to, actinidioionoside (CAS registry number 540528-05-0), bridelionoside B (CAS registry number 917877-38-4), (3S,5R,6R,7E,9S)-megastigman-7-ene-3,5,6,9-tetrol 9-O-β-D-glucopyranoside (CAS registry number 539857-33-5), bridelionoside C (CAS registry number 208929-31-1), euodionoside D (CAS registry number 1033434-17-1), debiloside C (CAS registry number 866033-67-2), (2E)-1-Methyl-3-[(2S,4S)-1,2,4-trihydroxy-2,6,6-trimethylcyclohexyl]-2-propen-1-yl β-D-glucopyranoside (CAS registry number 1639422-34-6) or β-D-glucopyranoside, (2E)-1-methyl-3-[(1R,2R,4S)-1,2,4-trihydroxy-2,6,6-trimethylcyclohexyl]-2-propen-1-yl (CAS registry number 1373256-48-4).

### 2-(Hydroxymethyl)-6-((4-(1,4,5-trihydroxy-2,2,6-trimethylcyclohexyl)but-3-en-2-yl)oxy)tetrahydro-2H-pyran-3,4,5-triol (Structure 7)

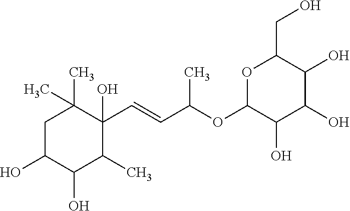 [SMILES: CC(/C=C/C1(O)C(C)C(O)C(O)CC1(C)C)OC1OC(CO)C(O)C(O)C1O]

Structure 7 may further specifically represent, for example, but not limited to, (2E)-1-methyl-3-[(4S,5S,6S)-1,4,5-trihydroxy-2,2,6-trimethylcyclohexyl]-2-propen-1-yl β-D-glucopyranoside (CAS registry number 223586-68-3).

### 2-((4-(4,5-Dihydroxy-2,2,6-trimethylcyclohexyl)but-3-en-2-yl)oxy)-6-(hydroxymethyl)tetrahydro-2H-pyran-3,4,5-triol (Structure 8)

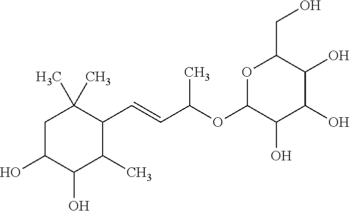 [SMILES: CC(/C=C/C1C(C)C(O)C(O)CC1(C)C)OC1OC(CO)C(O)C(O)C1O]

Structure 8 may further specifically represent, for example, but not limited to, elaeocarpionoside (CAS registry number 1232683-60-1), gynostemoside C (CAS registry number 1227614-13-2) or 3-(4,5-dihydroxy-2,2,6-trimethylcyclohexyl)-1-methyl-2-propen-1-yl β-D-glucopyranoside (CAS registry number 181864-64-2).

### 2-((4-(4,5-Dihydroxy-2,6,6-trimethylcyclohex-2-en-1-yl)but-3-en-2-yl)oxy)-6-(hydroxymethyl)tetrahydro-2H-pyran-3,4,5-triol (Structure 9)

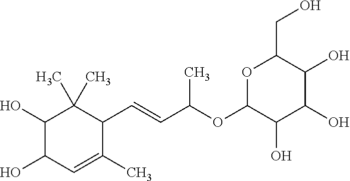 [SMILES: CC1=CC(O)C(O)C(C)(C)C1/C=C/C(C)OC1OC(CO)C(O)C(O)C1O]

Structure 9 may further specifically represent, for example, but not limited to, 2-((4-(4,5-dihydroxy-2,6,6-trimethylcyclohex-2-en-1-yl)but-3-en-2-yl)oxy)-6-(hydroxymethyl)tetrahydro-2H-pyran-3,4,5-triol (CAS registry number 2265882-70-8).

### 2-((4-(4-Hydroxy-2,2,6-trimethyl-7-oxabicyclo[4.1.0]heptan-1-yl)but-3-en-2-yl)oxy)-6-(hydroxymethyl)tetrahydro-2H-pyran-3,4,5-triol (Structure 10)

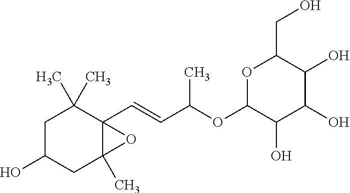 [SMILES: CC(/C=C/C12OC1(C)CC(O)CC2(C)C)OC1OC(CO)C(O)C(O)C1O]

Structure 10 may further specifically represent, for example, but not limited to, R-D-glucopyranoside, 3-(4-hydroxy-2,2,6-trimethyl-7-oxabicyclo[4.1.0]hept-1-yl)-1-methyl-2-propen-1-yl (CAS registry number 172823-80-2), sammangaoside A (CAS registry number 380305-20-4), 3-hydroxy-5,6-epoxy-β-ionyl-β-D-glucopyranoside (CAS registry number 228867-32-1), phlomuroside (CAS registry number 326793-91-3), β-D-glucopyranoside, (1R,2E)-3-[(1S,4R,6R)-4-hydroxy-2,2,6-trimethyl-7-oxabicyclo[4.1.0]hept-1-yl]-1-methyl-2-propen-1-yl (CAS registry number 1023641-17-9) or euodionoside C (CAS registry number 1033434-16-0).

### 2-((2-Hydroxy-4-(3-hydroxybut-1-en-1-yl)-3,5,5-trimethylcyclohex-3-en-1-yl)oxy)-6-(hydroxymethyl)tetrahydro-2H-pyran-3,4,5-triol (Structure 11)

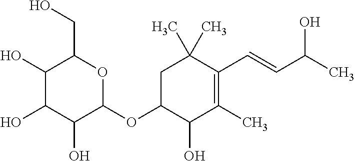 [SMILES: CC1=C(/C=C/C(C)O)C(C)(C)CC(OC2OC(CO)C(O)C(O)C2O)C1O]

Structure 11 may further specifically represent, for example, but not limited to, alangionoside D (CAS registry number 165306-60-5), plucheoside B (CAS registry number 126005-76-3) or staphylionoside E (CAS registry number 866033-70-7).

### 2-((3,4-Dihydroxy-4-(3-hydroxybut-1-en-1-yl)-3,5,5-trimethylcyclohexyl)oxy)-6-(hydroxymethyl)tetrahydro-2H-pyran-3,4,5-triol (Structure 12)

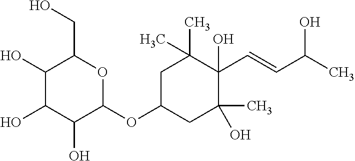 [SMILES: CC(O)/C=C/C1(O)C(C)(C)CC(OC2OC(CO)C(O)C(O)C2O)CC1(C)O]

Structure 12 may further specifically represent, for example, but not limited to, (3S,5R,6R,7E,9S)-megastigm-7-ene-3,5,6,9-tetrol 3-(β-D-glucopyranoside) (CAS registry number 539857-32-4), stratioside II (CAS registry number 141897-12-3) or foliasalacioside K (CAS registry number 1363802-85-0).

The terms “megastigmane” and “megastigmane derivative” mean the same and refer to the megastigmane derivative represented by Formula I and Formula II as described herein. The term “a megastigmane derivative” refers to one or more of the megastigmane derivative represented by Formula I and Formula II as described herein. Some preferred megastigmane derivatives include lauroside A, ampelopsisionoside, bridelionoside F, phlomisionoside, actinidioionoside, (3S,5R,6R,7E,9S)-megastigm-7-ene-3,5,6,9-tetrol 3-(β-D-glucopyranoside), stratioside II, 3-hydroxy-5,6-epoxy-β-ionyl-β-D-glucopyranoside, staphylionoside E, plucheoside B, alangionoside D, roseoside or a combination thereof.

The term “sugar moiety” refers to a natural or a modified sugar group that can be linear or cyclic. The sugar moiety of the present invention includes, for example, but not limited to, a monosaccharide, a disaccharide or a derivative thereof. The sugar moiety of the present invention includes, for example, but not limited to, glucose, fructose, sucrose, galacturonic acid or a derivative thereof. A preferred sugar moiety of the present invention is glucose.

Megastigmane derivatives can be prepared synthetically, exemplified by schemes 1 and 2 as follows:

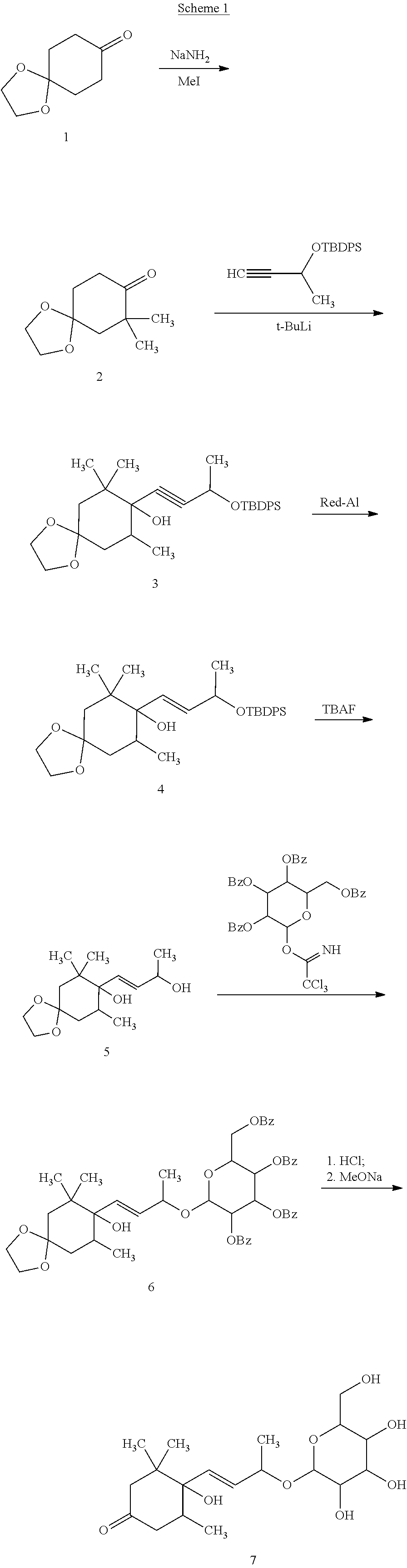

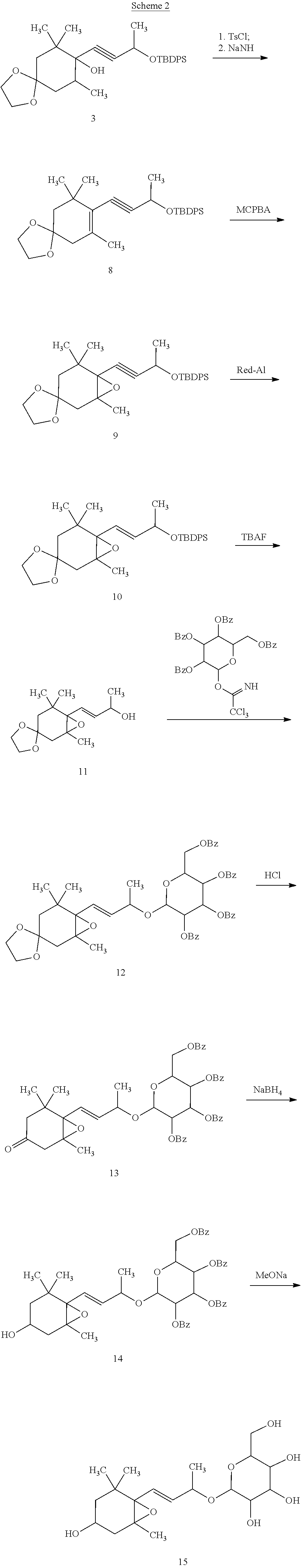

wherein Mel represents methyl iodide, OTBDPS represents —O-tert-butyl((1-methylpropargyl)oxy)diphenylsilane, t-BuLi represents tert-butyllithium, Red-Al represents sodium bis(2-methoxyethoxy)aluminium hydride, TBAF represents tetra-n-butylammonium fluoride, Bz represents benzoate and MeoNa represents sodium methoxide; and
wherein TsCl represents 4-toluenesulfonyl chloride and MCPBA represents meta-chloroperoxybenzoic acid.

Compounds 1-7 represent 1,4-dioxaspiro[4.5]decan-8-one, 7,7-dimethyl-1,4-dioxaspiro[4.5]decan-8-one, 8-(3-((tert-butyldiphenylsilyl)oxy)but-1-yn-1-yl)-7,7,9-trimethyl-1,4-dioxaspiro[4.5]decan-8-ol, 8-(3-((tert-butyldiphenylsilyl)oxy)but-1-en-1-yl)-7,7,9-trimethyl-1,4-dioxaspiro[4.5]decan-8-ol, 8-(3-hydroxybut-1-en-1-yl)-7,7,9-trimethyl-1,4-dioxaspiro[4.5]decan-8-ol, 2-((benzoyloxy)methyl)-6-((4-(8-hydroxy-7,7,9-trimethyl-1,4-dioxaspiro[4.5]decan-8-yl)but-3-en-2-yl)oxy)tetrahydro-2H-pyran-3,4,5-triyl tribenzoate and 4-hydroxy-3,3,5-trimethyl-4-(3-((3,4,5-trihydroxy-6-(hydroxymethyl)tetrahydro-2H-pyran-2-yl)oxy)but-1-en-1-yl)cyclohexan-1-one (Structure 1), respectively; and compounds 8-15 represent tert-butyldiphenyl((4-(7,9,9-trimethyl-1,4-dioxaspiro[4.5]dec-7-en-8-yl)but-3-yn-2-yl)oxy)silane, tert-butyldiphenyl((4-(1,5,5-trimethyl-7-oxaspiro[bicyclo[4.1.0]heptane-3,2′-[1,3]dioxolan]-6-yl)but-3-yn-2-yl)oxy)silane, tert-butyldiphenyl((4-(1,5,5-trimethyl-7-oxaspiro[bicyclo[4.1.0]heptane-3,2′-[1,3]dioxolan]-6-yl)but-3-en-2-yl)oxy)silane, 4-(1,5,5-trimethyl-7-oxaspiro[bicyclo[4.1.0]heptane-3,2′-[1,3]dioxolan]-6-yl)but-3-en-2-ol, 2-((benzoyloxy)methyl)-6-((4-(1,5,5-trimethyl-7-oxaspiro[bicyclo[4.1.0]heptane-3,2′-[1,3]dioxolan]-6-yl)but-3-en-2-yl)oxy)tetrahydro-2H-pyran-3,4,5-triyl tribenzoate, 2-((benzoyloxy)methyl)-6-((4-(2,2,6-trimethyl-4-oxo-7-oxabicyclo[4.1.0]heptan-1-yl)but-3-en-2-yl)oxy)tetrahydro-2H-pyran-3,4,5-triyl tribenzoate, 2-((benzoyloxy)methyl)-6-((4-(4-hydroxy-2,2,6-trimethyl-7-oxabicyclo[4.1.0]heptan-1-yl)but-3-en-2-yl)oxy)tetrahydro-2H-pyran-3,4,5-triyl tribenzoate and 2-((4-(4-hydroxy-2,2,6-trimethyl-7-oxabicyclo[4.1.0]heptan-1-yl)but-3-en-2-yl)oxy)-6-(hydroxymethyl)tetrahydro-2H-pyran-3,4,5-triol, respectively.

Those with skill in the art will recognize that some of the megastigmane derivatives of the present invention contain chiral centers, thereby providing a number of stereoisomers. It is intended herein that the compounds of the present invention include isomeric mixtures as well as individual isomers that may be separated using techniques known to those having skill in the art. Suitable techniques include chromatography such as high performance liquid chromatography, referred to as HPLC, particularly silica gel chromatography and gas chromatography trapping known as GC trapping. Yet, commercial versions of such products are mostly offered as mixtures.

Megastigmane derivatives are also obtainable from plants such as, for example, but not limited to, Annona muricate, Hippophae rhamnoides, Eriobotrya japonica, Antidesma bunius, Pinus densiflora, Phlomis bovei Noe, Psychotria luzoniensis, Uncaria rhynchophylloides, Diospyros maritima, Passiflora incarnata Linn., Opuntia humifusa, Tripterygium wilfordii, Physalis angulate, Phoebe tavoyana, Euphorbia thymifolia, Fissistigma polyanthoides, Picea brachytyla, Hibiscus tiliaceus, Persea Americana, Euscaphis konishii, Nitraria sibirica, Ulmus davidiana var. japonica, Salvia willeana, Vitex negundo var. heterophylla, Laurus nobilis, Corispermum mongolicum Iljin, Piper crocatum, Thalictrum delavayi, Datura metel, Corispermum mongolicum, Berchemiella wilsonii, Lyonia ovalifolia, Wrightia antidysenterica, Wedelia chinensis, Leathesia nana, Leontopodium leontopodioides, Eucommia ulmoides Oliver, Wrightia religiosa, Cinnamomum cassia, Urena lobate, Tribulus terrestris, Zanthoxylum ailanthoides, Sideroxylon, Apium graveolens, Juglans regia, Hosta plantaginea, Moringa oleifera, Anchusa italica, Viola kunawarensis, Aquilaria sinensis, Isodon japonicus, Sedum sarmentosum, Camellia bugiamapensis, Manglietia aromatica, Chorisia chodatii, Zanthoxylum schinifolium Sieb, Euphorbia laurifolia, Docynia indica, Agastache rugosa, Meliosma lepidota, Korean ginseng, Garcinia mangostana, Tecomella undulata, mangrove Avicennia marina, Cassia auriculate, Lagopsis supina, Miliusa balansae, Nectandra cuspidate, Uvaria grandiflora, Sedum aizoon, Syzygium samarangense, Cordia rothii, Osmanthus fragrans var. aurantiacus, Cleome brachycarpa, Nepalese sandalwood Osyris wightiana Wall ex Wight, Spiraea prunifolia var. simpliciflora, Linum usitatissimum L, Salsola komarovii, Aceriphyllum rossii, Sarcopyramis nepalensis Wall, Akebia quinate, Cichorium calvum, Antidesma pentandrum var. barbatum, Cirsium setosum, Vitis heyneana Roem. & Schult (Vitaceae), Polygala tenuifolia, Kalanchoe tubiflora, Cinnamomum wilsonii, Unonopsis lindmanii (Annonaceae), Nelumbo nucifera, Antidesma ghaesembilla, Dendropanax dentiger, Euphorbia hirta, Ficus aripuanensis, Gynura bicolor, Holostylis reniformis, Atriplex halimus, Erythronium japonicum, Vitis quinguangularis Rehd, Psychotria gitingensis, Ouratea polyantha, Aster yomena Makino, Sarcandra glabra, Artabotrys hexapetalus, Alisma orientale, Croton oblongifolius Roxburgh, Telekia speciose, Litsea glutinosa, Ajuga decumbens Thunb, Sinocrassula indica, Salvia dichroantha, Symplocos cochinchinensis var. philippinensis, Annona muricate, Asclepias syriaca, Phoenix dactylifera, Caralluma adscendens, Tricalysia dubia, Aleurites moluccana, Litsea glutinosa, Hylomecon vernalis, Cardamine komarovii, Ruellia patula, Gelsemium elegans, Distylium racemosum, Arcangelisia gusanlung, Clausena lansium, Indigofera zollingeriana, Guettarda speciosa L., Ficus callosal and Centaurea ensiformis. Preferably, a megastigmane derivative is provided as a botanical extract of a plant selected from the group consisting of Eriobotrya japonica, Antidesma bunius, Diospyros maritima, Passiflora incarnata Linn., Opuntia humifusa, Persea americana, Laurus nobilis, Garcinia mangostana, Syzygium samarangense, Antidesma pentandrum var. barbatum, Cirsium setosum, Cinnamomum wilsonii, Antidesma ghaesembilla, Vitis quinguangularis Rehd, Annona muricate and Phoenix dactylifera. Megastigmane derivatives are also commercially available.

If provided as a botanical extract, preferably the extract is enriched for a megastigmane derivative to achieve a content of about 0.01% and greater. For example, the botanical extract contains a megastigmane derivative from about 0.05% to about 95%, from about 0.1% to about 50% or from about 0.2% to about 10%. Unless otherwise specified, percentages (% s) are by weight. The term “a sweetness modifier” refers to a sweetener that provides a sweet taste, which includes a natural sweetener and an artificial sweetener. A natural sweetener includes, for example, but not limited to, sucrose, fructose, glucose, high fructose corn syrup, Stevia rebaudiana compositions including pure components of Reb A, stevioside, rebaudioside D (Reb D), xylose, arabinose or rhamnose, as well as sugar alcohols such as erythritol, xylitol, mannitol, sorbitol, inositol and a combination thereof. An artificial sweetener includes, for example, but not limited to, aspartame, sucralose, neotame, acesulfame potassium, saccharin and a combination thereof.

A flavoring is a preparation that provides a consumable with a particular taste and/or smell. A flavoring with modifying properties is a subset of the flavoring. It is added to the consumable to reduce off-notes and/or improve overall profile. The flavorings with modifying properties of the present invention include, for example, but not limited to, a stevia composition including stevioside, steviolbioside Reb A, rebaudioside B (Reb B), rebaudioside C (Reb C), Reb D, rebaudioside E (Reb E), rebaudioside F (Reb F), dulcoside A, dulcoside B, rubusoside, alpha-glucosyl stevia, fructosyl stevia, galactosyl stevia, beta-glucosyl stevia, siamenoside, mogrosidc IV, mogroside V, Luo Han Guo, monatin, glycyrrhizic acid, thaumatin, a salt thereof, a glycosylated derivative thereof and a combination thereof. The glycosylated derivatives can be prepared via transglycosylation reactions with, for example, but not limited to, glucose, fructose, galactose, rhamnose, ribose, mannose, arabinose, fucose, maltose, lactose, sucrose, rutinose, sorbose, xylulose, ribulose, rhammulose and xylose. In one embodiment, the flavorings with modifying properties of the present invention include Reb A, Reb C, rubusoside, Reb D, mogroside V, Luo Han Guo, monatin acid, a salt thereof, a glycosylated derivative thereof and a combination thereof. The flavorings with modifying properties of the present invention exhibit weak intrinsic sweetness. Some other flavorings of the present invention include, for example, but not limited to, curculin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, cyclocarioside I and a combination thereof.

The term “sweetness” or “sweetness intensity” refers to the relative strength of sweet sensation as observed or experienced by an individual, e.g., a human, or a degree or amount of sweetness detected by a taster, for example on the scale from 0 (none) to 8 (very strong) used in sensory evaluations according to the procedure described in American Society for Testing Materials, Special Technical Publication-434: “Manual on Sensory Testing Methods,” ASTM International, West Conshohocken, PA. (1996).

The term “a sweetness enhancer” refers to a preparation that enhances or intensifies the perception of the sweet taste of a sweetness modifier or a flavoring. A sweetness enhancer provides sweetness enhancement without providing any noticeable sweetness by itself at its general use levels.

The terms “synergy,” “synergistic effect” and “synergistic sweetness enhancement” mean the same and refer to a combination according to the present invention having a sweetness enhancement greater than the sum of the sweetness enhancement of all the sweetness enhancers present in said combination, when taken individually. In one embodiment, the synergistic sweetness is provided by the combination of a megastigmane derivative and a flavoring. In another embodiment, the flavoring is a stevia composition. In yet another embodiment, the megastigmane derivative and the stevia composition have a weight ratio of about 1:10-10⁶, preferably from about 1:50-5000 and more preferably form about 1:100-1000.

The term “olfactory effective amount” is understood to mean the amount of a sweetness enhancer including a megastigmane derivative, a stevia composition or a mixture thereof used in a combination with a sweetness modifier, wherein the sweetness enhancer enhances the sweetness of the sweetness modifier. Its olfactory effective amount may vary depending on many factors including other ingredients, their relative amounts and the olfactory effect that is desired. Any amount of a sweetness enhancer that provides the desired degree of sweetness enhancement without exhibiting off-taste can be used. In certain embodiments, the olfactory effective amount of a sweetness enhancer containing a megastigmane derivative ranges from about 0.1 ppb to about 500 ppm, preferably from about 1 ppb to about 100 ppm and more preferably form about 10 ppb to about 10 ppm. In certain embodiments, the olfactory effective amount of a sweetness enhancer containing a mixture of a megastigmane derivative and a stevia composition ranges from about 1 ppm to about 5000 ppm by weight, preferably from about 10 ppm to about 2000 ppm by weight and more preferably from about 100 ppm to about 1000 ppm by weight. In addition, megastigmane derivatives provide mouthfeel at 10 ppb and greater.

A consumable includes, for example, a food product (e.g., a beverage), a sweetener such as a natural sweetener or an artificial sweetener, a pharmaceutical composition, a dietary supplement, a nutraceutical, a dental hygienic composition and a cosmetic product. The consumable may further contain a flavoring.

In some embodiments, a consumable is a food product including, for example, but not limited to, fruits, vegetables, juices, meat products such as ham, bacon and sausage, egg products, fruit concentrates, gelatins and gelatin-like products such as jams, jellies, preserves and the like, milk products such as yogurt, ice cream, sour cream and sherbet, icings, syrups including molasses, corn, wheat, rye, soybean, oat, rice and barley products, nut meats and nut products, cakes, cookies, confectionaries such as candies, gums, fruit flavored drops, chocolates, chewing gums, mints, creams, pies and breads. In a certain embodiment, the food product is a beverage including, for example, but not limited to, coffee, tea, carbonated soft drinks, such as COKE and PEPSI, non-carbonated soft drinks and other fruit drinks, sports drinks such as GATORADE and alcoholic beverages such as beers, wines and liquors. A consumable also includes prepared packaged products, such as granulated flavor mixes, which upon reconstitution with water provide non-carbonated drinks, instant pudding mixes, instant coffee and tea, coffee whiteners, malted milk mixes, pet foods, livestock feed, tobacco and materials for baking applications, such as powdered baking mixes for the preparation of breads, cookies, cakes, pancakes, donuts and the like. A consumable also includes diet or low-calorie food and beverages containing little or no sucrose. Consumables further include condiments such as herbs, spices and seasonings, flavor enhancers (e.g., monosodium glutamate), dietetic sweeteners and liquid sweeteners. A preferred consumable includes carbonated beverages, yogurt, plant-based foods and beverages and savory products. A consumable also includes a vegan mayonnaise, a vegan pasta, a vegan egg, a vegan custard, a vegan soup, a vegan sauce, a vegan baked goods, a vegan dairy product (e.g., a vegan yogurt, a vegan ice cream and a vegan cheese), a vegan meat, a vegetarian mayonnaise, a vegetarian pasta, a vegetarian egg, a vegetarian custard, a vegetarian soup, a vegetarian sauce, a vegetarian baked goods, a vegetarian dairy product (e.g., a vegetarian yogurt, a vegetarian ice cream and a vegetarian cheese), a vegetarian meat and alike.

In other embodiments, a consumable is a pharmaceutical composition, a dietary supplement, a nutraceutical, a dental hygienic composition or a cosmetic product. Preferred compositions are pharmaceutical compositions containing a megastigmane derivative, one or more pharmaceutically acceptable excipients and one or more active agents that exert a biological effect other than sweetness enhancement. Such active agents include pharmaceutical and biological agents that have an activity other than taste enhancement. Such active agents are well known in the art (See, e.g., The Physician's Desk Reference). Such compositions can be prepared according to procedures known in the art, for example, as described in Remington's Pharmaceutical Sciences, Mack Publishing Co., Easton, PA. In one embodiment, such an active agent includes a bronchodilator, an anorexiant, an antihistamine, a nutritional supplement, a laxative, an analgesic, an anesthetic, an antacid, a H2-receptor antagonist, an anticholinergic, an antidiarrheal, a demulcent, an antitussive, an antinauseant, an antimicrobial, an antibacterial, an antifungal, an antiviral, an expectorant, an anti-inflammatory agent, an antipyretic and a mixture thereof. In another embodiment, the active agent is selected from the group consisting of an antipyretic and analgesic, e.g., ibuprofen, acetaminophen or aspirin, a laxative, e.g., phenolphthalein dioctyl sodium sulfosuccinate, an appetite depressant, e.g., an amphetamine, phenylpropanolamine, phenylpropanolamine hydrochloride, caffeine, an antacid, e.g., calcium carbonate, an antiasthmatic, e.g., theophylline, an antidiarrheal, e.g., diphenoxylate hydrochloride, an agent against flatulence, e.g., simethecon, a migraine agent, e.g., ergotamine tartrate, a psychopharmacological agent, e.g., haloperidol, a spasmolytic or sedative, e.g., phenobarbital, an antihyperkinetic, e.g., methyldopa or methylphenidate, a tranquilizer, e.g., a benzodiazepine, hydroxyzine, meprobramate or phenothiazine, an antihistaminic, e.g., astemizol, chlorpheniramine maleate, pyridamine maleate, doxlamine succinate, brompheniramine maleate, phenyltoloxamine citrate, chlorcyclizine hydrochloride, pheniramine maleate or phenindamine tartrate, a decongestant, e.g., phenylpropanolamine hydrochloride, phenylephrine hydrochloride, pseudoephedrine hydrochloride, pseudoephedrine sulfate, phenylpropanolamine bitartrate or ephedrine, a beta-receptor blocker, e.g., propranolol, an agent for alcohol withdrawal, e.g., disulfuram, an antitussive, e.g., benzocaine, dextromethorphan, dextromethorphan hydrobromide, noscapine, carbetapentane citrate, chlophedianol hydrochloride, a fluorine supplement, e.g., sodium fluoride, a local antibiotic, e.g., tetracycline or clindamycin, a corticosteroid supplement, e.g., prednisone or prednisolone; an agent against gout, e.g., colchicine or allopurinol, an antiepileptic, e.g., phenytoin sodium, an agent against dehydration, e.g., electrolyte supplements, an antiseptic, e.g., cetylpyridinium chloride, a NSAID, e.g., acetaminophen, ibuprofen, naproxen or a salt thereof, a gastrointestinal active agent, e.g., loperamide and famotidine, an alkaloid, e.g., codeine phosphate, codeine sulfate or morphine, a supplement for trace elements, e.g., sodium chloride, zinc chloride, calcium carbonate, magnesium oxide, and other alkali metal salts and alkali earth metal salts; a vitamin, an ion-exchange resin, e.g., cholestyramine, a cholesterol-depressant and lipid-lowering substance, an antiarrhythmic, e.g., N-acetylprocainamide and an expectorant, e.g., guaifenesin. Examples of dietary supplements or nutraceuticals include, for example, but are not limited to, an enteral nutrition product for treatment of nutritional deficit, trauma, surgery, Crohn's disease, renal disease, hypertension, obesity and the like, to promote athletic performance, muscle enhancement or general well-being or inborn errors of metabolism such as phenylketonuria. In particular, such compositions can contain one or more amino acids which have a bitter or metallic taste or aftertaste. Such amino acids include, for example, but are not limited to, an essential amino acid such as L isomers of leucine, isoleucine, histidine, lysine, methionine, phenylalanine, threonine, tryptophan, tyrosine and valine. Dental hygienic compositions are known in the art and include, for example, but not limited to, a toothpaste, a mouthwash, a plaque rinse, a dental floss, a dental pain reliever (such as ANBESOL) and the like. In one embodiment, the dental hygienic composition includes one natural sweetener. In another embodiment, the dental hygienic composition includes more than one natural sweetener. In yet another embodiment, the dental hygienic composition includes sucrose and corn syrup, or sucrose and aspartame. A cosmetic product includes, for example, but not limited to, a face cream, a lipstick, a lip gloss and the like. Other suitable cosmetic products of use in this invention include a lip balm, such as CHAPSTICK or BURT'S BEESWAX Lip Balm.

Plants containing megastimane derivatives have long been used in cooking and folk medicine to prevent and/or treat diseases such as, for example, dyspepsia, cold, viral infection and diabetes (Kamel et al., Phytochemistry (2000) 55: 353-357; Marino et al., J. Agric. Food Chem. (2004) 52: 7525-7531). More recent research has reported that megastimane derivatives possess potential anti-inflammatory activity and possible effect against scavenging radical as well as hepatoprotective activities (Pan et al., Front. Pharmacol. (2019) November 28; Rao et al., Chemistry International (2017) 3(1): 69-91). However, no sweet taste modulation function has ever been reported or even suggested for megastimane derivatives.

In the present invention, megastigmane derivatives have been for the first time to possess an unexpected and advantageous use in taste modulation. In particular, a megastigmane derivative or a mixture thereof has been found to enhance the sweetness of sweetness modifiers without undesirable off-notes.

Accordingly, the present invention provides a method of using a megastigmane derivative or a mixture thereof to enhance the sweetness of a sweetness modifier and decrease the amount of a sweetness modifier used in a consumable.

In addition, the present invention also provides methods for enhancing the sweetness of a flavoring with modifying properties and decreasing its use level in a consumable by incorporating a megastigmane derivative. In one embodiment, the invention provides a consumable containing an olfactory effective amount of a megastigmane derivative and a flavoring with modifying properties in a reduced amount in order to achieve the same level of sweetness when the flavoring with modifying properties is used alone in a traditional amount. In this respect, the amount of flavoring with modifying properties used in a consumable can be reduced by at least about 10%, 20%, 30%, 40%, 50%, 60%, 70%, 80%, 90% or 95%, from about 60% to about 99% or from about 20% to about 50%.

As indicated, a megastigmane derivative can be used in a consumable as a sweetness enhancer, which retains a desired sweetness but contains lower amounts of a natural sweetener or an artificial sweetener. For example, an improved carbonated soft drink can be produced with the same sweetness as the known carbonated soft drink but with lower sugar content by adding a megastigmane derivative.

Additional materials can also be used in conjunction with a megastigmane derivative of the present invention to encapsulate and/or deliver the lingering aftertaste masking effect. Some well-known materials are, for example, but not limited to, polymers, oligomers, other non-polymers such as surfactants, emulsifiers, lipids including fats, waxes and phospholipids, organic oils, mineral oils, petrolatum, natural oils, perfume fixatives, fibers, starches, sugars and solid surface materials such as zeolite and silica. Some preferred polymers include polyacrylate, polyurea, polyurethane, polyacrylamide, polyester, polyether, polyamide, poly(acrylate-co-acrylamide), starch, silica, gelatin and gum Arabic, alginate, chitosan, polylactide, poly(melamine-formaldehyde), poly(urea-formaldehyde) or a combination thereof.

The following are provided as specific embodiments of the present invention. Other modifications of this invention will be readily apparent to those skilled in the art. Such modifications are understood to be within the scope of this invention. Materials were purchased from Aldrich Chemical Company unless noted otherwise. As used herein all percentages are weight percent unless otherwise noted, ppm is understood to stand for parts per million, L is understood to be liter, mL is understood to be milliliter, g is understood to be gram, Kg is understood to be kilogram, mol is understood to be mole, mmol is understood to be millimole, psig is understood to be pound-force per square inch gauge and mmHg be millimeters (mm) of mercury (Hg). IFF as used in the examples is understood to mean International Flavors & Fragrances Inc., New York, NY, USA.

### Example I: Preparation of Sample Solutions

A sucrose base solution (4%) (“base”) was prepared in water.

Solutions of lauroside A, ampelopsisionoside, bridelionoside F and actinidioionoside were prepared in water (0.01%).

### Example II: Flavor Profiles of Megastigmane Derivatives

The flavor profiles of various megastigmane derivative solutions in water including lauroside A (0.5 ppm), ampelopsisionoside (0.5 ppm), bridelionoside F (0.5 ppm), actinidioionoside (0.5 ppm) and roseoside solutions (0.5 ppm) were each compared with that of sucrose solution (1.5%). While the sucrose solution tasted slightly sweet, none of the megastigmane derivation solutions exhibited a sweet taste.

### Example III: Enhancement of Sucrose Sweetness

The solutions of lauroside A, ampelopsisionoside, bridelionoside F and actinidioionoside (0.01%) were added to the base, respectively, to a final concentration of 0.5 ppm. The flavor profiles of the sucrose base solution with added megastigmane derivatives are reported in the following:

| Sample (0.5 ppm) | Flavor Profile |
|---|---|
| Base | Sweet, with mouthfeel |
| Lauroside A | Enhanced sweetness and mouthfeel, mouth coating, |
| | slightly brown mouthfeel, slightly fatty |
| Ampelopsisionoside | Enhanced sweetness and mouthfeel with cola- and |
| | lime-like flavors |
| Bridelionoside F | Enhanced sweetness and mouthfeel with para |
| | cymene-like end note |
| Actinidioionoside | Enhanced sweetness and mouthfeel |

When used with sucrose, all the above megastigmane derivatives enhanced overall sweetness and mouthfeel.

### Example IV: Sweetness Enhancement of Megastigmane Derivatives at Different Concentrations

Roseoside was added to the base to provide a series of solutions with concentrations ranging from 1 ppb to 5 ppm. The flavor profile of the sucrose solution with added roseoside is reported in the following:

| Sample | Flavor Profile |
|---|---|
| Base | Sweet, with mouthfeel |
| Roseoside (1 ppb) | Slightly enhanced sweetness and viscous mouthfeel |
| Roseoside (10 ppb) | Slightly enhanced and lingering sweetness, viscous |
| | mouthfeel followed by slight astringency |
| Roseoside (100 ppb) | Slightly enhanced and lingering sweetness, viscous |
| | mouthfeel |
| Roseoside (1 ppm) | Slightly enhanced and lingering sweetness, viscous |
| | mouthfeel and slight astringency |
| Roseoside (5 ppm) | More enhanced and lingering sweetness, slight |
| | astringency |

### Example V: Sweetness Enhancement of a Consumable

A solution of Megastigmane derivative mixture (0.4 ppm) containing lauroside A (0.1 ppm), ampelopsisionoside (0.1 ppm), bridelionoside F (0.1 ppm) and actinidioionoside (0.1 ppm) is prepared. The sweetness enhancement of the megastigmane derivative mixture is evaluated in various food products and is reported in the following:

| Consumable with Added | |
|---|---|
| Megastigmane Derivatives | Flavor Profile |
| Sucrose-containing yogurt | Increased sweetness, body and mouthfeel |
| | with reduced sourness |
| Stevia-containing beverage | Increased upfront sweetness and syrupy |
| | mouthfeel |
| Non-dairy oat beverage with | Creamy mouthfeel with reduced off-note |
| chickpea powder | |
| Ketchup | Smoother and richer mouthfeel with |
| | reduced sourness |
| Beef broth | Richer mouthfeel |

### Example VI: Enhancement of Mouthfeel

Mouthfeel enhancement provided by roseoside (0.5 ppm) is tested in water and reported in the following:

| Sample | Flavor Profile |
|---|---|
| Roseoside (0.5 ppm) | Slight astringency, not sweet |
| Roseoside (2 ppm) | Slight astringency, very slight bitterness, slightly |
| | thicker and fuller mouthfeel with heaviness, not |
| | sweet |
| Roseoside (5 ppm) | Slight astringency, thicker and fuller mouthfeel with |
| | heaviness, not sweet |

What is claimed is:

1. A method of enhancing the sweetness of a sweetness modifier comprising the step of adding to the sweetness modifier an olfactory effective amount of a megastigmane derivative of Formula I: 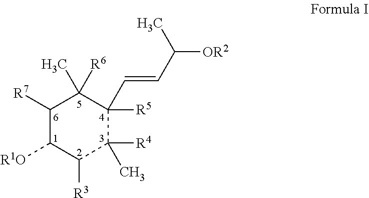
wherein one of R¹ and R² represents hydrogen and the other one thereof represents a sugar moiety;
R³, R⁴, R⁵, R⁶ and R⁷ are independently selected from the group consisting of hydrogen, a methyl group and a hydroxy group, or R⁴ and R together form a group —O—; and
wherein a dashed line represents an optional carbon-carbon double bond, with the proviso that the dashed line between carbon atom 2 and carbon atom 3 and the dashed line between carbon atom 3 and carbon atom 4 do not simultaneously represent a carbon-carbon double bond; and
with the further proviso that when the dashed line between carbon atom 1 and oxygen represents a carbon-carbon double bond, R¹ is absent, when the dashed line between carbon atom 2 and carbon atom 3 represents a carbon-carbon double bond, R⁴ is absent, and when the dashed line between carbon atom 3 and carbon atom 4 represents a carbon-carbon double bond, R⁴ and R⁵ are absent.

2. The method of claim 1, wherein the megastigmane derivative having Formula II: 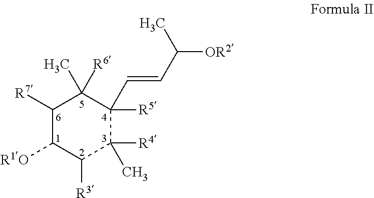
wherein R^{1′} represents hydrogen and R^{2′} represents a sugar moiety;
R^{3′}, R^{4′}, R^{5′}, R^{5′} and R^{7′} are independently selected from the group consisting of hydrogen, a methyl group and a hydroxy group; and
wherein a dashed line represents an optional carbon-carbon double bond, with the proviso that the dashed line between carbon atom 2 and carbon atom 3 and the dashed line between carbon atom 3 and carbon atom 4 do not simultaneously represent a carbon-carbon double bond; and
with the further proviso that when the dashed line between carbon atom 1 and oxygen represents a carbon-carbon double bond, R¹ is absent, when the dashed line between carbon atom 2 and carbon atom 3 represents a carbon-carbon double bond, R⁴ is absent, and when the dashed line between carbon atom 3 and carbon atom 4 represents a carbon-carbon double bond, R⁴ and R⁵ are absent.

3. The method of claim 2, wherein the megastigmane derivative is selected from the group consisting of lauroside A, ampelopsisionoside, bridelionoside F, phlomisionoside, actinidioionoside, (3S,5R,6R,7E,9S)-megastigm-7-ene-3,5,6,9-tetrol 3-(β-D-glucopyranoside), stratioside II, 3-hydroxy-5,6-epoxy-β-ionyl-β-D-glucopyranoside, staphylionoside E, plucheoside B, alangionoside D, roseoside and a mixture thereof.

4. The method of claim 1, wherein the sweetness modifier is a natural sweetener selected from the group consisting of sucrose, fructose, glucose, high fructose corn syrup, rebaudioside A, stevioside, rebaudioside D, xylose, arabinose, rhamnose, erythritol, xylitol, mannitol, sorbitol, inositol and a combination thereof.

5. The method of claim 1, wherein the sweetness modifier is an artificial sweetener selected from the group consisting of aspartame, sucralose, neotame, acesulfame potassium, saccharin and a combination thereof.

6. The method of claim 1, wherein the olfactory effective amount is from about 0.1 ppb to about 500 ppm of the sweetness modifier.

7. The method of claim 1, wherein the olfactory effective amount is from about 1 ppb to about 100 ppm of the sweetness modifier.

8. The method of claim 1, wherein the olfactory effective amount is from about 10 ppb to about 10 ppm of the sweetness modifier.

9. The method of claim 1, wherein the megastigmane derivative is provided as a botanical extract of a plant selected from the group consisting of Eriobotrya japonica, Antidesma bunius, Diospyros maritima, Passiflora incarnata Linn., Opuntia humifusa, Persea americana, Laurus nobilis, Garcinia mangostana, Syzygium samarangense, Antidesma pentandrum var. barbatum, Cirsium setosum, Cinnamomum wilsonii, Antidesma ghaesembilla, Vitis quinguangularis Rehd, Annona muricate and Phoenix dactylifera.

10. The method of claim 1, wherein the method further comprising the step of adding an olfactory effective amount of a flavoring.

11. The method of claim 10, wherein the flavoring is stevia composition.

12. The method of claim 11, wherein the olfactory effective amount is from about 1 ppm to about 5000 ppm of the sweetness modifier.

13. The method of claim 11, wherein the megastigmane and the stevia composition have a weight ratio of about 1:50-5000.

14. A composition comprising a sweetness modifier and a sweetness enhancer containing a megastigmane derivative.

15. The composition of claim 14, wherein the sweetness enhancer further comprising a stevia composition.

16. The composition of claim 14, wherein the sweetness modifier is a natural sweetener selected from the group consisting of sucrose, fructose, glucose, high fructose corn syrup, rebaudioside A, stevioside, rebaudioside D, xylose, arabinose, rhamnose, erythritol, xylitol, mannitol, sorbitol, inositol and a combination thereof.

17. The composition of claim 14, wherein the sweetness modifier is an artificial sweetener selected from the group consisting of aspartame, sucralose, neotame, acesulfame potassium, saccharin and a combination thereof.

18. The composition of claim 14, wherein the megastigmane derivative is selected from the group consisting of lauroside A, ampelopsisionoside, bridelionoside F, phlomisionoside, actinidioionoside, (3S,5R,6R,7E,9S)-megastigm-7-ene-3,5,6,9-tetrol 3-(β-D-glucopyranoside), stratioside II, 3-hydroxy-5,6-epoxy-β-ionyl-β-D-glucopyranoside, staphylionoside E, plucheoside B, alangionoside D, roseoside and a mixture thereof.

19. The composition of claim 15, wherein the megastigmane and the stevia composition have a weight ratio of about 1:50-5000.

20. A consumable comprising a sweetness modifier and a sweetness enhancer containing a megastigmane derivative and a stevia composition, wherein the megastigmane and the stevia composition have a weight ratio of about 1:50-5000.
